(19) United States
(12) Patent Application Publication
(10) Pub. No.: US 2014/0282855 A1
(43) Pub. Date: Sep. 18, 2014

(54) MODELING NETWORK DEVICES FOR BEHAVIOR ANALYSIS

(71) Applicant: FireMon, LLC, Overland Park, KS (US)

(72) Inventors: Patrick G. Clark, Overland Park, KS (US); Jody Brazil, Shawnee, KS (US)

(73) Assignee: FireMon, LLC, Overland Park, KS (US)

(21) Appl. No.: 14/209,771

(22) Filed: Mar. 13, 2014

Related U.S. Application Data
(60) Provisional application No. 61/780,555, filed on Mar. 13, 2013.

(51) Int. Cl. H04L 29/06

(52) U.S. Cl. CPC H04L 63/20
USPC 726/1

(57) ABSTRACT

Implementations of the present disclosure involve a system and/or method for modeling a firewall function and operation such that software based analysis and other formal analysis methods may be used with the model. In one embodiment, the system and/or method includes modeling the function of a firewall as a set of links, ingress/egress interfaces, interface switches and behaviors chained together into a spanning graph. The spanning graph may then be used in conjunction with data structures, such as a Firewall Policy Diagram, to illustrate pathways through a network for a communication packet. This system and/or method allows for the understanding of a firewall policy such that the policy can be replicated among various firewalls in the network at issue.

### CROSS-REFERENCE TO RELATED APPLICATIONS

This application claims priority under 35 U.S.C. §119(e) to U.S. Provisional Application No. 61/780,555 entitled “MODELING FIREWALLS FOR BEHAVIOR ANALYSIS”, filed on Mar. 13, 2013 which is incorporated by reference in its entirety herein.

### FIELD OF THE DISCLOSURE

Aspects of the present invention relate to networks of computing devices and, more particularly, aspects of the present invention involve network devices, such as Open Systems Interconnection (OSI) Layer 3 network devices like firewalls, routers and switches and the security, routing, and translation functions associated with such devices. Use of the term “firewall” and “firewall device” throughout this document refers to such OSI Layer 3 network devices and functions associated with such devices.

### BACKGROUND

Computer networking has been one of the most important advancements in modern computing. Allowing disparate applications operating on separate computer systems to trade information, conduct business, exchange financial transactions, and even the routine act of sending an email are some of the most common things we do with computers today. Even with the advancement of ever faster computing devices, the trend continues to connect devices at an astounding rate. In addition, there is also a thriving mobile device market, thus increasing the amount of traffic flowing between systems over any number of networks. The need to connect computing devices or networks such that the devices can communicate safely is essential to today's marketplace.

One important aspect of this interconnected network of computer systems and devices is security. Without security, the convenience and speed of networked transactions would present more risk than the majority of applications could handle. In order to mitigate that risk and provide a much more secure communication channel, a firewall device is typically deployed in most networks. In general, a firewall device is a software or hardware-based device that controls incoming and outgoing traffic to/from a network through an ordered set of rules, collectively referred to as a firewall policy. The primary purpose of a firewall is to act as the first line of defense against malicious and unauthorized traffic from affecting a network, keeping the information that an organization does not want out, while allowing approved access to flow into and out of the network.

While a static firewall policy may somewhat protect a network, a firewall policy with the ability to adapt to the ever-changing environment of a network, such as the Internet, allows the firewall to defend against the newest types of malicious attacks. However, as new attacks are discovered and new rules for addressing or handling those new attacks are added to a firewall's rule-base, management of a firewall policy quickly becomes overwhelming for network managers or engineers. Many firewall devices today include rule-sets with thousands of rules that continually grow as more and more threats to the network are identified. As such, the ability to accurately and confidently understand a firewall policy and know what changes have occurred is more difficult than ever and continues to increase in complexity with every passing day.

In addition to individual firewall policies consisting of a list of rules, attempting to model the entire firewall introduces an additional set of attributes possessed by most modern firewall vendors. Multiple ingress and egress interfaces, traffic routing tables, multiple security policies, and network address translation (NAT) broaden the definition of a firewall such that modeling the behavior of a firewall becomes more than an ordered list of rules. Therefore, the ability to accurately and confidently understand the firewall device and know what changes have occurred are more difficult than ever, and continue to increase in complexity.

It is with these and other issues in mind that various aspects of the present disclosure were developed.

### SUMMARY

One implementation of the present disclosure may take the form of method for modeling behavior of a networking device. The method includes the operations of obtaining a plurality of behavior rules, the plurality of behavior rules defining the processing of a communication packet by the networking device, the communication packet comprising at least one predicate value and collecting the plurality of behavior rules into at least one behavior group. The method further includes creating, utilizing a processing device, a spanning graph of a policy of the networking device comprising representations of one or more ingress ports to the networking device, representations of one or more egress ports from the networking device, and representations of the at least one behavior group, the spanning graph configured to display a communication pathway comprising at least one of the one or more ingress ports, the at least one behavior group, and at least one egress port of the networking device and providing the spanning graph to a user of the network device.

Another implementation of the present disclosure may take the form of a non-transitory computer-readable medium encoded with instructions for modeling behavior of a network device, the instructions executable by a processor. The instructions include the operations of obtaining a plurality of behavior rules from a policy of the network device, the plurality of behavior rules defining the processing of a communication packet by the network device, the communication packet comprising at least one predicate value and collecting the plurality of behavior rules into at least one behavior group representation such that the at least one behavior group representation comprises a portion of the plurality of behavior rules. In addition, the instructions include creating a spanning graph comprising representations of one or more ingress ports to the network device, representations of one or more egress ports from the network device, at least one behavior group representation, and at least one directed edge between the representations of one or more ingress ports, the at least one behavior group representation and the representations of one or more egress ports such that the flow indicator displays a communication pathway of a communication packet through the network device and providing the spanning graph to a user of the network device.

Yet another implementation of the present disclosure takes the form of a system for modeling a network policy rule set. The system includes a processing device and a computer-readable medium with one or more executable instructions stored thereon. When the instructions are executed, the system performs the operations of obtaining a plurality of behavior rules from the network policy rule set, the plurality of behavior rules defining the processing of a communication packet by the network device and collecting the plurality of behavior rules into a plurality of behavior groups representations such that each of the plurality of behavior groups representations comprise a portion of the plurality of behavior rules. In addition, the instructions include creating a spanning graph of the network policy comprising representations of one or more ingress ports to the network device, representations of one or more egress ports to the network device, the representations of the plurality of behavior groups, and at least one directed edge between the representations of one or more ingress ports, the representations of the plurality of behavior groups and the representations of one or more egress ports such that the flow indicator displays a communication pathway of a communication packet through the network device and providing the spanning graph to a user of the network device.

### BRIEF DESCRIPTION OF THE DRAWINGS

FIG. 1 illustrates an example network environment that may implement various systems and methods of the present disclosure.

FIG. 2 is an example access control table for a firewall interface.

FIG. 3 is an example routing table for a firewall interface.

FIG. 4 is an example network address translation table for a firewall interface.

FIG. 5 is a flow chart illustrating a method for modeling the behavior or communication paths through a firewall.

FIG. 6A is an example spanning graph that represents the function of a firewall device with a routing and security group.

FIG. 6B is the spanning graph of FIG. 6A with an integrated interface switch.

FIG. 7 is an example spanning graph that represents the function of a firewall device obtained through the operations of the flowchart of FIG. 5.

FIG. 8 illustrates a spanning graph that utilizes virtual routing behavior groups comprising virtual routing behavior rules.

FIG. 9 illustrates a spanning graph that utilizes an interface switch for illustration of modeling multiple zone policies with a global policy utilizing multiple interface switches.

FIG. 10 is a flowchart illustrating a method for utilizing a Firewall Policy Diagram with a spanning graph of a firewall function.

FIG. 11 is a binary decision diagram representing a particular rule of a firewall rule set.

FIG. 12 is a block diagram illustrating an example of a computing system which may be used in implementing embodiments of the present disclosure.

### DETAILED DESCRIPTION

Implementations of the present disclosure involve a system and/or method for modeling a firewall device function such that the model may be used with software based analysis and other formal analysis methods. As mentioned above, use of the term “firewall” and “firewall device” throughout this document refers to OSI Layer 3 network devices (such as routers, firewalls, and switches) and functions associated with such devices. In one embodiment, the system and/or method includes converting one or more rules of the firewall function into a string of representative bits, creating a binary decision diagram or other decision diagram from the converted rules of the firewall policy, creating a spanning graph for the firewall or firewall policy and collapsing or simplifying the spanning graph to a behavior group that illustrates the pathways through the firewall for a communication packet. This system and/or method allows for the understanding of a firewall transfer function such that the policy can be replicated among various firewalls in the network at issue.

Through the embodiments described herein, the system provides several uses when applied to firewalls in a network. For example, network trace analysis for understanding how a packet will traverse through the firewall device without physically sending the packet is provided. In addition to an individual packet, a packet space of each possible packet instance in the form of a Firewall Policy Diagram may traverse the network to understand what will make it from point A to point B. One such Firewall Policy Diagram is described in related U.S. patent application Ser. No. 14/209,574, titled “SYSTEM AND METHOD FOR MODELING A NETWORKING DEVICE POLICY” to Clark and filed on Mar. 13, 2014, the entirety of which is incorporated by reference herein. Further, logical comparisons of firewall vendor implementations are possible. If two firewalls are configured to behave the exact same way but are from two different implementations, modeling the behavior of each vendor in software allows formal verification that the resulting address spaces of each ingress and egress are identical between the two implementations being tested. Subsequently, if they are not identical, the Firewall Policy Diagram used to traverse the spanning graph can tell you what is different from what is potentially a large solution space. Also, behavior modeling of specific firewall vendors serves as the basis for automated translation from one vendor configurations to another with certainty of how the device will behave. Finally, such modeling provides for the ability to participate in a larger software modeled network for more comprehensive simulations.

FIG. 1 illustrates an example network environment 100 that may implement various systems and methods of the present disclosure. In particular, the network environment 100 includes one or more computing devices 102 (which collectively could form a local area network), a firewall 104 and a wide area network 106, such as the Internet. The computing device 102 may include any type of computing devices, including but not limited to a personal computing devices such as a personal computer, a laptop, a personal digital assistant, a cell phone, and the like and one or more routing devices, such as a server, a router, and the like. In general, the computing devices 102 may include any type of device that processes one or more communication packets.

In addition, the wide area network 106 may include one or more other computing or routing devices. As mentioned above, the Internet is one example of a wide area network 106, but any type of wide area network comprising one or more computing devices is contemplated. The firewall 104 is in communication between the wide area network 106 and the computing device 102 and operates to analyze and potentially filter communication packets transmitted between the networks. The operation of the firewall 102 is described in more detail below. One of ordinary skill in the art will recognize the various ways and communication protocols through which the computing devices 102 can connect to the firewall 104 and the firewall can connect to the wide area network 106 for communication between the networks. For simplicity, the various ways for connecting the components of the network environment 100 are omitted.

In general, the firewall 104 allows the two networks 102, 106 to communicate through the transfer of communication packets, while securing the private network behind the firewall. The typical placement of a firewall 104 is at the entry point into a network 102 so that all traffic passes through the firewall to enter the network. The traffic that passes through the firewall 102 is typically based on existing packet-based protocols, and a packet can be thought of as a tuple with a set number of fields. For example, a packet may include such fields as a source/destination IP address, port number, and/or a protocol field, among other fields. A firewall 102 typically inspects or analyzes each packet that travels through it and decide if it should allow the packet to pass through the firewall based on a sequence of rules pertaining to the values of the one or more fields in the packet. For example, a packet may include a source IP address may be 10.2.0.1 and destination IP address may be 192.168.1.1. A firewall rule may utilize those values to determine whether the packet is allowed into the network 102 or denied. For example, the firewall 104 may determine any packet with a source IP address of 10.2.0.1 is denied entry into the network 102. As such, the decision portion of a rule determines what happens if the value matches to a true evaluation by matching a field to a condition value and determining if the matching is true. The rule then typically employs an accept or deny action on the packet, with the possibility of additional actions, such as an instruction to log the action. However, for the purpose of this disclosure, only the case of accept or deny is discussed herein for simplicity.

As discussed above, a firewall policy is generally made up of an ordered list of these rules such that as a packet is processed by the firewall, the firewall attempts to match some aspect of the packet to the rules one rule at a time, from beginning of the rule list to the end. Matching the packet means that the firewall evaluates a packet based on the fields in the rule tuple to determine if the fields match the values identified in the rule. The rule does not necessarily need to contain a value for all possible fields and can sometimes contain an “any” variable in a field to indicate that the rule is a “do not care” condition for that variable. In general, these rules are processed in order until the firewall finds a match and takes the appropriate action identified by the decision portion of the rule.

While traditional firewalls filter communications based on a local security policy applied to each communication packet entering the firewall, many firewall vendors have continued to increase the scope of what defines a firewall. Many modern firewalls typically include a combination of router, network address translation (NAT), and filtering capabilities. In addition, each of these sub-components may be broken down further into other elements such as: virtual routers, embedded NAT inside of rules, and multiple filtering policies applied at different places. Therefore, to obtain an abstraction of a firewall function, these capabilities are also represented so that accurate results may be computed.

For example, many firewalls employ many interfaces into and out of the device between the communicating networks. Thus, the firewall may have multiple ingress and egress ports. Such ports may be considered during an abstraction of the firewall function. Also, a firewall will often have one or multiple security policies to be applied to incoming or outgoing traffic. FIG. 2 is an example of one such access control table for a firewall interface illustrating a rule set of a firewall 104 for a particular network 102. In particular, the rule set 200 of FIG. 2 includes five rules, numbered in the far right column 202 of the table. Column 204 indicates the action taken for each of the rules when the conditions of the rules are met and columns 206-216 provide the identifiers or portions of the packet that define the packet for each individual rule, otherwise known as the predicate of the rule. As shown in column 204, the rule set 200 either provides for allowing or denying the packet into the network when the predicate matches a received packet. Although only two actions are shown in the rule set 200 of FIG. 2, other actions may also be taken by the firewall, such as logging.

The predicate portion of the rules of the rule set 200 includes columns 206-216. In particular, column 206 establishes a source address or range of source addresses for each rule. For example, rule 1 of the rule set applies to packets with a source address of 192.168/16, while rule 2 applies to packets with a source address outside of 192.168/16. In a similar manner, column 208 includes a destination address for each particular rule. For example, rule 1 applies for a packet with a destination packet outside of 192.168/16. Column 210 designates a type of communication protocol for each rule in the rule set, column 212 designates a source port number for each rule, column 214 designates a destination port number for each rule and column 216 designates a flag state for each rule. Further, although the rule set 200 of FIG. 2 includes the particular columns discussed above, a rule set may consider any aspect of a communication packet as a predicate for the rules 202 in the rule set.

In general, a firewall 104 receives a communication packet from the wide area network 106 or the local area network 102 and compares portions of the communication packet to the rules 202 in the rule set 200 of the firewall. Further, these rules are generally processed in order until the firewall finds a match and takes the appropriate action identified by the decision portion 204 of the rule. Using the rule set 200 of FIG. 2 as an example; the firewall 104 compares the source address 206, destination address 208, protocol 210, source portal identifier 212, destination portal identifier 214 and flag state 216 of the communication packet to the corresponding column 206-216 entry for rule 1 of the rule set. If each of the entries in predicate columns 206-216 matches the corresponding communication packet portions, then the firewall 104 takes the action described in column 204 for that particular rule. In this case, the packet would be allowed by the firewall 104. However, if one or more of the communication packet portions do not match the corresponding entry in the predicate columns 206-216, then the firewall 104 moves to the next rule (in this case rule 2) and performs the same operations. The firewall 104 continues in this manner until a rule is found in the rule set 200 that matches the predicates of the packet. For example, as shown in the rule set 200, if the packet does not match the predicates for rules 1-4, rule 5 includes a deny action for all predicates.

In a similar manner, a route can be defined as a simple one packet rule with a decision being the egress interface (or through which port the packet is transmitted). The one packet of the traffic being processed is the destination. For a particular routing rule, the destination can be identified as an IP Address, address range, or Classless Inter-Domain Routing (CIDR) format. Therefore, in a similar manner as security rules discussed above, the solution space can be split as the traffic is processed. Traffic is matched from top to bottom in the routing table. FIG. 3 is an example of a routing table 300 based on the routes through the firewall. Similar to the processing of the packet discussed above, the firewall may determine the egress port for any incoming communication packet by stepping through the routing table from top to bottom. Thus, for an example communication packet for address 10.20.5.5 being processed through the firewall, the routing table 300 would match the destination address in column 304 to the second rule in column 302 in the table and send traffic out of egress port labeled as “eth1” (as designated in column 306).

Another feature often provided by a firewall device is a Network Address Translation (NAT) feature. In general, the NAT feature allows private and public IP addresses to communicate. For example, in the current IP standards address format, there exist several realms of addresses that are not routable on the public Internet. Some non-routable address formats include 10.0.0/8, 172.16.0.0/12, and 192.168.0.0/16. The reasoning for this is to allow private networks that do not communicate directly to other private networks to share these address formats without fear of collision. Therefore, the NAT feature provides the means for two private networks with colliding address space to communicate through a border device, like a firewall.

Another consideration behind a NAT feature is that public Internet service providers typically charge for each public address and have a finite number available to them. Therefore for flexibility and cost savings, using a one to many relationship from external to internal outbound traffic is advantageous to an organization such that the border device looks like one device to the outside world but in reality is hiding many private hosts. Further, a NAT feature can be used is to provide a layer of security to the devices in the private network. Disguising the true location of secure resources an organization provides one more level of security to the organizations assets.

NAT implementation is typically performed through a translation table similar to that described above for routes and policies of the firewall. FIG. 4 is an example of one such NAT translation table. In general, inbound traffic to the firewall is matched to an entry (either source or destination address) in the table to be translated to another address on the egress side. The firewall device then keeps track of that conversation in order for response packets to have the reverse translation applied and arrive at the appropriate destination. Thus, for an example communication packet for address 192.168.2.1 being processed through the firewall, the translation table 400 would match the destination address in column 404 to the first rule in column 402 in the table and translate the address to address 74.125.228.39 (as designated in column 406). There are typically three types of NAT: source address translation (SNAT), destination address translation (DNAT) and port translation (PAT), each of which are contemplated within the embodiments for modeling the firewall behavior described herein.

In general, this sort of translation may occur on the packet being processed through the firewall. However, there are certain situations where the replacement is delayed until the egress interface is known. This is an example of a hide translation where the outgoing packet source address will assume the address of the egress interface, making the packet appear to have originated from the firewall and subsequently hiding the true origination. Furthermore, when the response is seen by the firewall, it may reverse the translation and send the traffic to the originating host (the intended recipient).

As described above, it is often useful to model or otherwise illustrate the paths through a firewall that a communication packet may take. In particular, it is often useful to determine the internal paths through the firewall that take the data through the various control and routing structures of the firewall. These paths and structures can be abstracted into behavior rules, behavior groups, interface switches and/or a spanning graph that illustrates the function of a firewall through the decomposition of steps into abstract elements.

FIG. 5 is a flowchart illustrating one method for modeling the behavior or communication paths through a firewall. In one embodiment of the method of FIG. 5, the operations are performed by a firewall device or computing device associated with a firewall and can be provided to an administrator of the firewall device or a related network to aid the administrator in managing the firewall function for a network. One such system is described in greater detail below with reference to FIG. 12. The operations of the flowchart of FIG. 5 may provide a summary of the behavior of the firewall that may be replicated to other firewall devices in the network, even to firewall devices that are of a different vendor.

Beginning in operation 502, the system determines the one or more behavior rules for the firewall function. To model the behavior rules, consider the elements discussed above, namely the routes, security rules, and NAT of a firewall device. In general, these three items may be thought of as consisting of a predicate and an action. The predicate defines the particulars of a communication packet that determine when a rule is applied, such as the source address, destination address, source port and destination port of the packet. Further, in general the actions that occur when the predicate matches are accept, deny or next action; with two additional state transition operators: translate and egress interface. Thus, when a predicate matches, an action may be applied (accept, deny, or next), but one or more of the state transition operators may be applied. These internal elements of the firewall function may be used to create one or more behavior groups and a spanning graph of the firewall device, as described in more detail below.

In operation 504, one or more behavior groups may be constructed from the grouping of the behavior rules of the abstracted firewall. A behavior group is a representation of a set of behavior rules that are typically processed top to bottom such that a first matching predicate for a particular individual packet performs the associated action. For example, the behavior group may model a particular routing behavior or a security policy behavior such that corresponding routes or security rules are in that group may potentially be processed as one entity. The use of behavior groups simplifies the represented firewall device of a spanning graph into smaller, more global rules.

In addition to providing a grouping mechanism for behavior rules, behavior groups may possess three actions: accept, deny and default. These actions may be linked to the next group in the spanning graph or potentially to the egress interface of the firewall. The behavior group accept action will be applied to a traversing packet when the packet has matched a behavior rule predicate and the related action was accept. In a similar manner, the behavior group deny action will follow the same logic but go to the deny path. Finally, the behavior group default action will be applied if no behavior rule predicate matched the packet.

In operation 506, the system may create a spanning graph from the behavior rules and behavior groups that models the behavior of the firewall function when processing communication packets through the firewall. FIG. 6A illustrates one example of a spanning graph of a firewall device. In particular, the spanning graph 602 includes two representations of ingress ports (illustrated in FIG. 6A as ingress ports “eth0” 604 and “eth1” 606), a representation of a routing behavior group 608, two representations of security policy behavior groups 610, 612, and two representations of egress ports (illustrated in FIG. 6A as ingress ports “eth0” 614 and “eth1” 616). Although illustrated here with these particular elements of the spanning graph, it should be appreciated that this is for example only and that a spanning graph of a typical firewall device may include several additional elements. The spanning graph 602 of FIG. 6A is provided for example purposes herein.

Through the spanning graph 602, an understanding of the transfer function of the firewall may be obtained. For example, ingress ports eth0 and eth1 604, 606 are subjected to the routing behavior group 608 as illustrated by the flow arrows into the routing behavior group. The rules contained within the routing behavior group 608 would be applied to communications entering through the ingress ports 604, 606. In particular, the routing behavior group identifies those communications with a destination address of 10.8.2.1 are transmitted to egress port eth1 614 and communications with a destination address of 192.168.10.2 are transmitted to egress port eth0 616. In addition, a security policy behavior group 610, 612 is associated with each of the egress ports 614, 616 shown in the spanning graph 602. The security policy behavior groups 610 define the communication packets that are accepted by the firewall for each egress port 614, 616, among other security policy behavior rules. Thus, associated with each security policy behavior group 610, 612 is an accept block 618, 622 and a deny block 620, 624 that illustrate the next step in the spanning graph 602 when the communication packet is accepted by the firewall or denied. In other words, if a communication packet is received that matches one of the behavior rules in the associated security policy behavior group, the communication is allowed to pass to the related egress port, as indicated by the accept blocks 618, 622. In this manner, through an analysis of the spanning graph 602, the behavior of the firewall's function may be obtained.

In addition to creating the spanning graph for the firewall function, the system may also simplify the spanning graph where applicable. For example, the spanning graph may include one or more interface switches that operate to reduce the number of paths through the spanning graph. In particular, interface switches may be placed in the behavior group model to act on two elements. The first is on inbound interface the traffic passes through the ingress ports. Additional interface switches may be located at the state transition behavior groups that identified the egress interface at some point in the spanning graph. FIG. 6B illustrates the spanning graph 602 of FIG. 6A, with an interface switch 652 at the egress port of the spanning graph. As can be seen in the spanning graph 650 of FIG. 6B, the security policy behavior groups for the egress ports 614, 616 of the spanning graph are combined into a single security policy behavior group 654. Thus, if the communication packet is accepted by the security policy group, the interface switch 652 then determines which egress port 614, 616 the communication packet is transmitted through. In this manner, the spanning graph 654 may be simplified for easier understanding and traversing.

An additional reason that interface switches may be useful is for firewalls that employ zone definitions. A zone in a firewall is typically a grouping of a number of interfaces into a logical area of the network. One such zone set-up is illustrated in FIG. 9 and discussed in more detail below. In one example, egress ports eth0 and eth1 may be considered an internal zone while egress ports eth2 and eth3 may be considered in an unsafe zone. A vendor may then identify a security policy when the traffic is passing from zone-to-zone and is specific to that zone-to-zone transition. In this example, there may exist a security policy that may be applied if the traffic came in the internal zone and is destined for the unsafe zone. Without an interface switch between the zones, there would be a path for every interface to interface combination, regardless if those interfaces shared the same zones, with the result being duplicated behavior groups and paths. As such, interface switches may be applied to reduce the number of duplicated behavior groups and paths.

Through the operations of FIG. 5, a spanning graph for a firewall device may be created that summarizes the behavior of the firewall transfer function for ease of understanding. Further, the spanning graph allows for simulation of the traffic to be based on interface origination. Also, the spanning graph may act as a way to compare two firewalls types that process traffic differently, but expect the same external results. FIG. 7 is an example spanning graph of a firewall function created through the operations described above. As should be appreciated, the spanning graph 702 is an example spanning graph for an example firewall device. A spanning graph for a firewall device may include fewer or more entries in the spanning graph to illustrate the behaviors of the firewall function.

As shown in FIG. 7, the spanning graph 702 may include one or more ingress ports (shown in FIG. 7 as “eth0” 704 and “eth1” 706 ingress ports). The spanning graph 702 also includes a routing behavior group 708 that receives the communications received on each ingress port 704, 706 and applies one or more behavior rules that determines a particular ingress/egress port for the destination address of the received communication packets. A security policy behavior group 710 is also included in the spanning graph 702. Similar to the routing behavior group 708, the security policy behavior group 710 includes one or more behavior rules that define when a communication packet is accepted or denied by the security policy. If accepted, the communication packet is passed to a destination network address translation (DNAT) behavior group 712, illustrated in FIG. 7 as the arrow from the accept box 714 of the security policy behavior group 710 to the DNAT behavior group. As also shown in FIG. 7, a communication packet that is denied by the security policy behavior group 710 is illustrated as being stopped by the firewall through the deny box 716.

As described above, the DNAT behavior group 712 contains one or more behavior rules that may translate the destination address for received communication packets. For example, the DNAT behavior group 712 of the spanning graph 702 contains the behavior rule that the destination address is hidden for communication packets received intended for address 10.8.2.1, among other behavior rules. The spanning graph 702 also includes interface switch 718 that determines which egress port the packet is sent through, and a representation of the egress ports “eth0” 722 and “eth1” 720. Thus, the spanning graph 702 is a descriptive graph of the behavior rules and groups for a firewall device such that an analysis of the graph provides insights into the firewall function.

To this point we have covered the general elements of the behavior model, such as a routing behavior group, security policy behavior group, or destination NAT behavior group. However, modern firewalls are often constructed of smaller elements that may be linked and reused. Constructs such as virtual routers and zone policies may easily be represented as their own behavior groups that are linked. For example, a virtual router is typically a routing table with an action of “next”, taking the processing to another group until finally an egress interface decision is made. FIG. 8 illustrates a spanning graph 802 that utilizes virtual routing behavior groups 804, 806 comprising virtual routing behavior rules. Furthermore, zone-to-zone policies may be represented by using an interface switch before selecting the security policy to be processed. FIG. 9 illustrates an example spanning graph 902 that utilizes a first interface switch 904 to select the zone policy 908, 910 and a second interface switch 906 again to select the egress interface in the spanning graph.

As mentioned above, the spanning graph of the firewall function may be used for tracing the behavior of individual packets through the firewall device. However, the spanning graph may be utilized in other respects. For example, utilizing a data structure capable of representing the entire solution space of the behavior group. Such a data structure is referred to herein as a Firewall Policy Diagram (FPD).

In general, a Firewall Policy Diagram is a set of data structures and algorithms used to model a communication packet space of N tuples into an entity allowing efficient mathematical operations. The FPD forms the base of the behavior modeling engine and allows the fast and efficient manipulation of that solution space. This achieves a complete and thorough understanding of the solution space as it comes in an ingress interface and exits another egress interface, yielding an accurate understanding of what traffic would have passed.

FIG. 10 is a flowchart illustrating a method for utilizing a Firewall Policy Diagram with a spanning graph abstraction of a firewall device. In one embodiment of the method of FIG. 10, the operations are performed by a firewall device or computing device associated with a firewall and can be provided to an administrator of the firewall device or a related network to aid the administrator in managing the firewall devices in a network. One such system is described in greater detail below with reference to FIG. 12.

Beginning in operation 1002, the computing device translates or represents each rule in the rule set defining the policy of the firewall device into one or more strings of bits. By representing each of the rules into one or more bit strings, a truth table of the rule set can be created. For example, a bit string may represent a value for one or more of the predicates associated with a rule in the rule set, such as a string of 32 bits may represent a value in the source address column 206. In this manner, the values in the source address column can be converted into bit strings for further processing of the rule set.

Similarly, other predicates of the rules of the rule set may be converted into representative bit strings. For example, a 32 bit string may represent the destination address values of a rule set, an 8 bit string may represent the protocol type, a 16 bit string may represent the source port number, and a 16 bit string may represent the destination port number. However, the bit strings representing any value in the predicate fields of the rules may include any number of bits in the representative bit string. Further, in some embodiments, only particular predicate values of the rules are converted into bit strings. For example, in one embodiment, only the values of the source address, destination address, protocol, and destination port are converted into bit strings. However, any field included in the packet may be used to analyze and model the rule set of the firewall function.

Upon conversion of one or more predicates of the rule set into binary strings, a binary decision diagram (BDD) of the rule set is created in operation 1004 for a particular rule or set space. A BDD is a diagram that visually represents a truth table of a function. An example BDD 1102 is illustrated in FIG. 11. In general, the diagram represents the result of the function depending on the values of the bits represented in the BDD 1102. In particular, the BDD 1102 of FIG. 11 illustrates a truth table for a function of an 8-bit string, represented in the table as bits 0-7. Each circle in the BDD 1102 represents a bit of the 8-bit string and a result of the function can be determined by following a path down the BDD to a terminal, represented as the squares at the bottom of the BDD. Further, the lines connecting the bits of the BDD 1102 indicate a high or low assertion of the bit. In particular, a solid line connecting two nodes indicates a high assertion of the particular bit and a dotted line indicates a low assertion of the particular bit. Thus, to determine the result of the function for a given eight bit string, a program begins at the top of the BDD 1102 and follows the appropriate connecting lines through the BDD based on the values of the bits of the string (either the solid line for a high assertion or a dotted line for a low assertion) until the terminal value is determined. In this manner, the BDD 1102 provides an illustrative diagram of a function of the 8-bit string. As should be appreciated, any type of BDD known or hereafter developed may be utilized by the disclosure described herein.

In one example, assume an 8-bit string of 11101100 that represents the predicate field of a rule of the rule set of the behavior group. Typically, the bit string for such a rule would consist of much more bits. However, the 8-bit string mentioned above is used for example purposes herein. Beginning at node “0” 1104 of the BDD 1102 of FIG. 11, the graph is traversed down the left arrow from the bit “0” circle 1104 as the value of the most significant bit of the string in this case is high, reaching node 1106 of the BDD. Node 1106 represents the value at bit “1” of the string, or the second most significant bit. This bit also includes an asserted value. Thus, the right arrow from node 1106 of the BDD 1102 is traversed to node 1108. Similarly, because the third most significant bit is also asserted, the left arrow is traversed from node 1108 to node 1110 (as a solid line represents an assertion at the bit associated with the particular node). A low or unasserted value at bit 3 traverses from node 1110 to node 1112. Continuing through the 8-bit string in this manner traverses from node 1112 to node 1114 and from node 1114 to node 1116. Because the value at bit position 6 is low or unasserted, bit position 7 (or the least significant bit of the string) is ignored and the resulting value of “1” or high 1118 is the output of the represented function. In a similar manner, the BDD may be traversed to determine the function result of any combination of bits in the eight bit string. As such, the BDD 1102 is a representation of an eight bit function corresponding to the example 8-bit string that represents the predicate field of a rule of the rule set of the firewall behavior group.

The BDD 1102 of FIG. 11 is merely an example of a BDD. It should be appreciated that such a diagram may be implemented for one or more bit strings of any length. Thus, in operation 1004 of the method of FIG. 10, the bit string representations of the predicates of the rules of the rule set are converted in a BDD 1102 that represents the rule set. For example, the 32 bit string representing the source address, the 32 bit string representing the destination address, the eight bits representing the protocol type and the 16 bits representing the destination port may be combined into a function and used to create a BDD 1102 that represents each rule of the rule set of the behavior group.

In operation 1006, the BDD graph of the potential traffic space is used to walk through the spanning graph illustrating the firewall device. In particular, the spanning graph is walked from an ingress port representation to an egress port representation with the FPD splitting and mutating as each behavior group is processed until it reaches the egress interface leaf. The FPD provides a mechanism through which the spanning graph can be walked to arrive at an egress port. In operation 1008, each leaf FPD result is OR'd or otherwise combined together to produce the final FPD at that egress leaf representing an accurate space of what traffic can pass through the firewall and out of that interface. In this manner, the spanning graph of a firewall device may be utilized with a Firewall Policy Diagram to obtain the behavior of the firewall device.

Through the operations of FIG. 10, an understanding of the firewall behavior may be obtained faster than through a straight-forward walking through the policy. In other words, attempting to match an incoming packet to the behavior rules as a firewall is a linear method, one behavior rule at a time to one packet at a time. While this is straightforward, it is also performance prohibitive as the full testing of a firewall configuration requires 2⁸⁸×br, where br is the number of behavior rules that exist in the device and the 2⁸⁸ is an example solution space represented by a BDD or FPD. Larger solution spaces would simply increase the complexity of the analysis.

However, with a formulation of behavior groups in a spanning graph, the processing time may now be bound to the number of decisions that must be made as opposed to the number of behavior rules. This will be substantially smaller than the number of rules and in most cases be considered constant time. As an example, consider a behavior group formed from a single security policy of a firewall containing 1,000 security rules. Each security has one of two decisions, accept or deny. Thus, the linear time processing would put the cost at 2⁸⁸×1,000. However, if we instead model the behavior group as two FPDs, one for the accept traffic and one for the deny traffic, the results become 2⁸⁸×2. Furthermore, we can make the entire operation constant by modeling the solution space as a FPD as well, replacing 2⁸⁸ with a constant 88 thus making it a constant time operation to know what is an accept and what is a deny and follow the paths appropriately.

FIG. 12 illustrates a computer system 800 capable of implementing the embodiments described herein. For example, the computer system 1200 described in relation to FIG. 12 may be a computing system, such as a desktop or laptop computer with one or more software programs stored thereon for performing the operations described above. The computer system (system) includes one or more processors 1202-1206. Processors 1202-1206 may include one or more internal levels of cache (not shown) and a bus controller or bus interface unit to direct interaction with the processor bus 1212. Processor bus 1212, also known as the host bus or the front side bus, may be used to couple the processors 1202-1206 with the system interface 1214. Processors 1202-1206 may also be purpose built for processing one or more computer-readable instructions.

System interface 1214 may be connected to the processor bus 1212 to interface other components of the system 1200 with the processor bus 1212. For example, system interface 1214 may include a memory controller 1218 for interfacing a main memory 1216 with the processor bus 1212. The main memory 1216 typically includes one or more memory cards and a control circuit (not shown). System interface 1214 may also include an input/output (I/O) interface 1220 to interface one or more I/O bridges or I/O devices with the processor bus 1212. One or more I/O controllers and/or I/O devices may be connected with the I/O bus 1226, such as I/O controller 1228 and I/O device 1230, as illustrated.

I/O device 1230 may also include an input device (not shown), such as an alphanumeric input device, including alphanumeric and other keys for communicating information and/or command selections to the processors 1202-1206. Another type of user input device includes cursor control, such as a mouse, a trackball, or cursor direction keys for communicating direction information and command selections to the processors 1202-1206 and for controlling cursor movement on the display device.

System 1200 may include a dynamic storage device, referred to as main memory 1216, or a random access memory (RAM) or other computer-readable devices coupled to the processor bus 1212 for storing information and instructions to be executed by the processors 1202-1206. Main memory 1216 also may be used for storing temporary variables or other intermediate information during execution of instructions by the processors 1202-1206. System 1200 may include a read only memory (ROM) and/or other static storage device coupled to the processor bus 1212 for storing static information and instructions for the processors 1202-1206. The system set forth in FIG. 12 is but one possible example of a computer system that may employ or be configured in accordance with aspects of the present disclosure.

According to one embodiment, the above techniques may be performed by computer system 1200 in response to processor 1204 executing one or more sequences of one or more instructions contained in main memory 1216. These instructions may be read into main memory 1216 from another machine-readable medium, such as a storage device. Execution of the sequences of instructions contained in main memory 1216 may cause processors 1202-1206 to perform the process steps described herein. In alternative embodiments, circuitry may be used in place of or in combination with the software instructions. Thus, embodiments of the present disclosure may include both hardware and software components.

A machine readable medium includes any mechanism for storing information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 1216. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A method for modeling behavior of a networking device, the method comprising:
obtaining a plurality of behavior rules, the plurality of behavior rules defining the processing of a communication packet by the networking device, the communication packet comprising at least one predicate value;
collecting the plurality of behavior rules into at least one behavior group;
creating, utilizing a processing device, a spanning graph of a policy of the networking device comprising representations of one or more ingress ports to the networking device, representations of one or more egress ports from the networking device, and representations of the at least one behavior group, the spanning graph configured to display a communication pathway comprising at least one of the one or more ingress ports, the at least one behavior group, and at least one egress port of the networking device; and
providing the spanning graph to a user of the networking device.

2. The method of claim 1 wherein at least one of the plurality of behavior rules comprises the at least one predicate value and an action portion, the at least one of the plurality of behavior rules configured to cause the networking device to perform the action portion of the at least one of the plurality of behavior rules when the communication packet matches the predicate value.

3. The method of claim 2 wherein the action portion of the at least one of the plurality of behavior rules defines an associated egress port from the one or more egress ports to the networking device for the communication packet.

4. The method of claim 2 wherein the action portion of the at least one of the plurality of behavior rules defines an associated translated field corresponding to a portion of the communication packet.

5. The method of claim 4 wherein the networking device replaces the portion of the communication packet with the translated field when the portion of the communication packet matches the at least one predicate value of the at least one of the plurality of behavior rules.

6. The method of claim 1 further comprising:
combining at least two behavior groups into an interface switch and wherein the spanning graph further comprises the interface switch in place of the at least two behavior groups.

7. The method of claim 1 wherein the action portion of the at least one of the plurality of behavior rules defines an associated virtual router for the communication packet.

8. The method of claim 6 wherein the plurality of behavior rules define a security policy for a communication packet between a plurality of designated zones within the networking device.

9. The method of claim 1 wherein providing the spanning graph to a user of the networking device comprises displaying the spanning graph on a display device.

10. A non-transitory computer-readable medium encoded with instructions for modeling behavior of a network device, the instructions, executable by a processor, comprising:
obtaining a plurality of behavior rules from a policy of the network device, the plurality of behavior rules defining the processing of a communication packet by the network device, the communication packet comprising at least one predicate value;
collecting the plurality of behavior rules into at least one behavior group representation such that the at least one behavior group representation comprises a portion of the plurality of behavior rules;
creating a spanning graph comprising representations of one or more ingress ports to the network device, representations of one or more egress ports from the network device, the at least one behavior group representation, and at least one flow indicator between the representations of one or more ingress ports, the at least one behavior group representation and the representations of one or more egress ports such that the flow indicator displays a communication pathway of a communication packet through the network device; and
providing the spanning graph to a user of the network device.

11. The non-transitory computer-readable medium of claim 10, wherein at least one of the plurality of behavior group representations is a security policy behavior group representation and wherein at least one of the plurality of behavior rules comprises the predicate value and an action portion, the at least one of the plurality of behavior rules configured to cause the network device to perform the action portion when the communication packet matches the predicate value of the at least one of the plurality of behavior rules.

12. The non-transitory computer-readable medium of claim 11, wherein the at least one behavior group representation is a routing behavior group representation and wherein the action portion of the at least one of the plurality of behavior rules defines an associated egress port from the one or more egress ports to the network device of the communication packet.

13. The non-transitory computer-readable medium of claim 11, wherein the at least one behavior group representation is a network address translation behavior group, and wherein the action portion of the at least one of the plurality of behavior rules defines an associated translated field corresponding to a portion of the communication packet.

14. The non-transitory computer-readable medium of claim 13 wherein the network device replaces the portion of the communication packet with the translated field when the portion of the communication packet matches the at least one predicate value of the at least one of the plurality of behavior rules.

15. The non-transitory computer-readable medium of claim 10, the instructions further comprising:
modeling a portion of the plurality of behavior rules from the policy of the network device as a plurality of bit strings; and
creating a first hierarchical decision diagram from the plurality of bit strings.

16. The non-transitory computer-readable medium of claim 15, the instructions further comprising:
applying the first hierarchical decision diagram to the spanning graph to obtain one or more policy rules from the policy of the network device.

17. A system for modeling a network device policy rule set, the system comprising:
a processing device; and
a computer-readable medium with one or more executable instructions stored thereon, wherein the processing device executes the one or more instructions to perform the operations of:
obtaining a plurality of behavior rules from the network device policy rule set, the plurality of behavior rules defining the processing of a communication packet by the network device, wherein at least one of the plurality of behavior rules comprises a predicate value and an action portion;
creating a plurality of behavior group representations comprising the plurality of behavior rules such that each of the plurality of behavior group representations comprise a portion of the plurality of behavior rules;
forming a spanning graph of the network device policy rule set comprising representations of one or more ingress ports to the network device, representations of one or more egress ports from the network device, the plurality of behavior group representations, and at least one flow indicator between the representations of one or more ingress ports, the plurality of behavior group representations and the representations of one or more egress ports such that the flow indicator displays a communication pathway of a communication packet through the network device; and
providing the spanning graph to a user of the network device.

18. The system of claim 17 further comprising:
a display device configured to display the spanning graph to the user of the network device.

19. The system of claim 17 wherein at least one behavior group representation is a routing behavior group representation and wherein the action portion of the at least one of the plurality of behavior rules defines an associated egress port from the one or more egress ports to the network device of the communication packet.

20. The system of claim 17 wherein the network device is a firewall device.
